(19) United States
(12) Patent Application Publication
(10) Pub. No.: US 2005/0105107 A1
(43) Pub. Date: May 19, 2005

(54) Image printing system and method

(76) Inventors: David A. Schneider, Fort Collins, CO (US); John A. Mick, Fort Collins, CO (US); John M. Carleton, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/714,775

(22) Filed: Nov. 17, 2003

(51) Int. Cl. G06K 1/00

(52) U.S. Cl. 358/1.9

(57) ABSTRACT

An image printing system comprises a graphics application executable by a processor. The graphics application is adapted to print image graphics data in a print area of a media object. The graphics application is also adapted to print image notation data to an extension area of the media object.

### TECHNICAL FIELD

This invention relates to imaging devices and, more particularly, to an image printing system and method.

### BACKGROUND

Many printers for use independently or with a personal computer are capable of printing color images. Economical ink-jet printers and more expensive laser jet printers with color printing capabilities have found great demand in the consumer electronics market. The increasing use of digital cameras and other imaging devices has provided greater demand for photo-quality color printers. Moreover, many photo inkjet and laser printers include memory card interfaces thus enabling a user to print photos of digitally captured images without the use of a personal computer.

A common feature of photo printers is referred to as borderless printing. A paper media, such as photo quality glossy paper, comprises a main print area and an adjacent tab connected to the print area by a perforation. In operation, the paper media is fed into the printer and an image is printed onto the print area. In borderless printing, after tab removal, the image spans the length and width of the print area of the paper media such that a borderless image is produced.

However, when a borderless image is placed into a photo album or other type of media organizer, a notation relating to the image, such as a date the image was captured, the names of subjects within the image, a location where the image was captured, and/or any other type of information relating to the image, is generally placed on the back of the image. Thus, during later viewing, the photograph or image must be repeatedly removed from the organizer to view the notation information located on the back of the image. Additionally, repeated handling of the image may damage the image or detrimentally affect the quality of the image.

### SUMMARY

In accordance with an embodiment of the invention, an image printing system comprises a graphics application executable by a processor. The graphics application is adapted to print image graphics data in a print area of a media object. The graphics application is also adapted to print image notation data to an extension area of the media object.

In accordance with another embodiment of the invention, an image printing method comprises receiving image graphics data and, via a graphics application, identifying image notation data associated with the image graphics data, printing the image graphics data to a print area of a media object, and printing the image notation data to an extension area of the media object.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a diagram illustrating an embodiment of an image printing system in accordance with the present invention;

FIGS. 2A and 2B are diagrams illustrating a media object for printing an image using the image printing system of the present invention; and

FIG. 3 is a flow diagram illustrating an embodiment of an image printing method in accordance with the present invention.

### DETAILED DESCRIPTION OF THE DRAWINGS

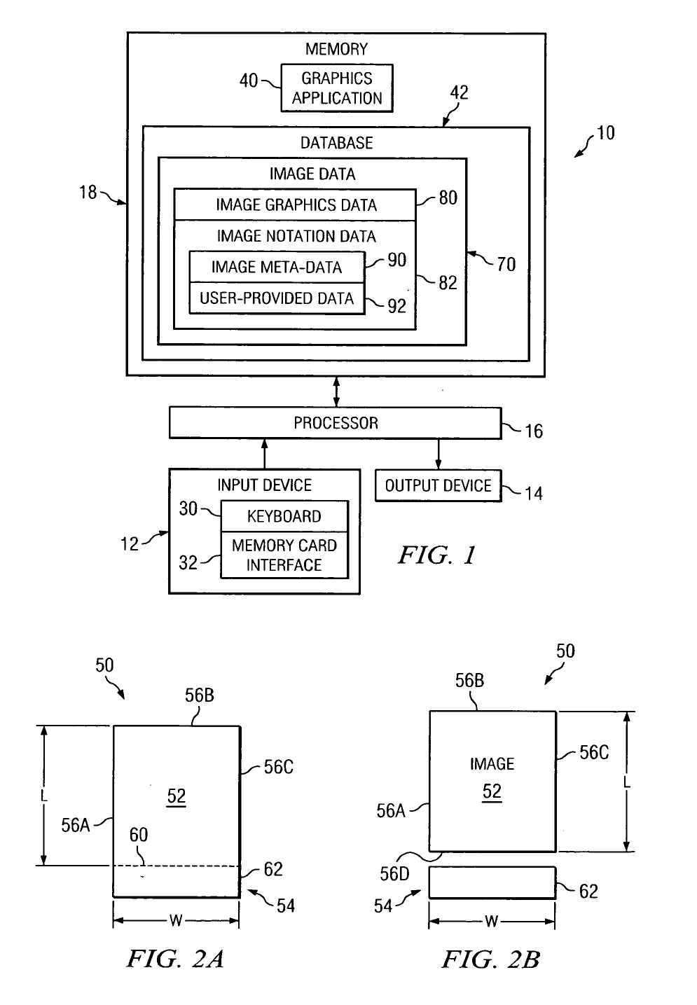

The preferred embodiment of the present invention and its advantages are best understood by referring to FIGS. 1 through 3 of the drawings, like numerals being used for like and corresponding parts of the various drawings.

FIG. 1 is a diagram illustrating an image printing system 10 in accordance with the present invention. System 10 may be disposed in or form part of any device adapted to perform a printing operation or any device adapted to communicate with a printing device for performing a printing operation. For example, system 10 may be disposed in or form part of a printing device such as, but not limited to, a laser printer assembly or an inkjet printer assembly. System 10 may also be disposed in or form part of a scanner, copier, or other type of image scanning device having printing capabilities. System 10 may also be disposed in or form part of a computer, such as a desktop computer of other type of computing system, coupled to a device having printing capabilities. Briefly, system 10 enables the acquisition and printing of notation information to an extension area of a media object adjacent to the image graphics content. The notation information may be included on a borderless image printing and either remain part of the media object or be easily removed to accommodate placement of the notation information adjacent to the borderless image in a photo album or other type of media organizer.

In the embodiment illustrated in FIG. 1, system 10 comprises an input device 12, an output device 14, a processor 16 and a memory 18. Input device 12 comprises any device for inputting information to system 10 such as, but not limited to, a keyboard 30 and a memory card interface 32. Input device 12 may also comprise other types of devices for receiving input from a user such as a microphone such that audible input may be received and converted to notation information. Input device 12 may be used by a user to input information to system 10. Input device 12 may also be used to input information to system 10 received from another resource such as, but not limited to, a computer. Preferably, memory card interface 65 is adapted to receive and read data from a variety of types of memory cards such as, but not limited to, COMPACTFLASH, SMARTMEDIA, MEMORY STICK, and SECURE DIGITAL. Output device 14 comprises any type of device or mechanism for outputting information from system 10 such as, but not limited to, a display, printer or printing mechanism.

In the embodiment illustrated in FIG. 1, system 10 comprises a graphics application 40 and a database 42. Graphics application 40 may comprise software, such as a photo-imaging utility, hardware, or a combination of software and hardware. In FIG. 1, graphics application 40 is illustrated as being stored in memory 18 so as to be accessible and executable by processor 16. However, it should be understood that graphics application 40 may be otherwise stored, even remotely, so as to be accessible and executable by processor 16. Briefly, graphics application 40 extracts notation information from an image file or data set, such as from header data associated with the image file, and/or receives notation information from a user via input device 12. Graphics application 40 prints the notation information to a designated area of a printing media object.

FIG. 2A is a diagram illustrating an embodiment of a media object 50 that may be used with system in accordance with the present invention. Media object 50 comprises any type of media for receiving printed content such as, but not limited to, glossy photo-quality paper. In the embodiment illustrated in FIG. 2A, media object 50 comprises a print area 52 and an extension area 54. Print area 52 is bounded by edges 56A-56C and a perforation 60 (illustratively denoted by dashed lines), thereby forming a perforated and removable tab 62. Tab 62 may be removed from media object 50, thereby creating media edge 56D as illustrated in FIG. 2B. Preferably, media object 50 comprises perforation 60 to enable easy removal of tab 62. However, it should also be understood that perforation 60 need not be provided such that a user may employ other methods to remove tab 62 from media object 50.

Returning to FIG. 1, system 10 also comprises image data 70. In FIG. 1, image data 70 is illustrated as being stored in database 42; however, it should be understood that storage of image data 70 may be temporary or unnecessary, thereby providing real time processing of image data 70 by system 10. In the embodiment illustrated in FIG. 1, image data 70 comprises image graphics data 80 and image notation data 82. Image graphics data 80 comprises an image data set and/or other information associated with defining an image. Image notation data 82 comprises notation information associated with the corresponding image such as, but not limited to, a date the image was acquired, the identity of a subject within the image, the location the image was acquired, and/or any other type of information associated with the image.

As illustrated in FIG. 1, image notation data 82 comprises notation information stored as image meta-data 90 and/or user-provided image notation data 92. For example, a data set defining the image may comprise meta-data 90 that is encoded, or otherwise associated, with the image file. A joint photographic expert group (JPEG) formatted image file supports encoding of meta-data 90 comprising descriptive information of the image data, such as colors, tones, author information, intellectual property rights information, details of the device used to capture the image, time and date information of image capture, and other data in accordance with the exchangeable image file format (EXIF) specification, the JPEG 2000 standard, or by way of another technique. Meta-data 90 is generally encoded in a JPEG header, but other techniques of associating meta-data 90 with an image file may also be used.

User-provided image notation data 92 comprises notation information received from a user via input device 12. Notation data 92 may comprise textual and/or audible information received from a user via input device 12. Graphics application 40 receives the user-input notation information and associates the user-input notation information with the corresponding image file.

Thus, in operation, graphics application 40 receives or retrieves image data 70 representing an image file and translates or otherwise manipulates image data 70 into a format suitable for printing. For example, image data 70 may be retrieved from database 42, read from a memory card via memory card interface 32, or acquired from another source such as a networked computer resource. Graphics application 40 identifies image graphics data 80 and translates or otherwise manipulates image graphics data 80 into a format suitable for printing.

Graphics application 40 also determines whether notation data 82 is associated with image data 70. For example, in some embodiments, graphics application 40 accesses a header associated with image graphics data 80 of image data 70 and decodes or otherwise extracts notation data 82 from image meta-data 90.

In some embodiments, graphics application 40 also receives user-provided notation data 92 from a user via input device 12 and/or retrieves user-provided notation data 92 from database 42. In some embodiments, system 10 is configured such that graphics application 40 uses either notation data 82 extracted from meta-data 90 or notation information received as user-provided data 92. In other embodiments, system 10 is configured to combine notation information extracted from meta-data 90 and received from a user via user-provided data 92. Graphics application 40 also translates or otherwise manipulates notation data 82 into a format suitable for printing.

In operation, graphics application 40 controls or otherwise causes image graphics data 80 of image data 70 to be printed within print area 52 of media object 50. Graphics application 40 also controls or otherwise causes notation data 82 to be printed on extension area 54 of media object 50. For example, as best illustrated in FIGS. 2A and 2B, notation data 82 is printed onto removable tab 62 of a media object 50 such that a user may remove tab 62, if desired, thereby creating a borderless image on media object 50 spanning the width (W) and length (L) of print area 52. In the embodiment illustrated in FIGS. 2A and 2B, extension area 54 comprises a width-wise tab 62 extending the entire width of media object 50. However, it should be understood the teachings of the present invention may be similarly implemented having varying lengths of extension area 54, multiple extension areas 54, and/or having a length-wise tab 62. In some embodiments, notation data 82 is printed onto extension area 54 located adjacent to print area 52. In other embodiments, notation data 82 may be printed onto extension area 54 located a predetermined distance from print area 52.

To facilitate printing of notation data 82 on extension area 54, graphics application 40 preferably comprises suitable logic for parsing meta-data 90 from image data 70. For example, typical image files comprise marker segments that designate the beginning of image data within a data set. A marker segment is often implemented as a unique bit-pattern. Accordingly, graphics application 40 comprises logic for recognizing image data 70 and is adapted to parse meta-data 90 therefrom. Additionally, meta-data 90 may comprise numerous fields of data. Preferably, graphics application 40 is adapted to parse a subset comprising one or more fields of data from meta-data 90 for printing on extension area 54. Graphics application 40 may also be configured to provide a user-prompt for selection of one or more desired meta-data 90 fields for printing on extension area 54 and parse contents of the user-specified meta-data 90 fields. Graphics application 40 may also be configured to combine information parsed from meta-data 90 with user-provided image notation data 92 for printing on extension area 54. Once meta-data 90 is parsed from image data 70, both image graphics data 80 and meta-data 90 are formatted for printing by graphics application 40. Graphics application 40 may be supplied with image graphics data 80 and meta-data 90 sequentially or graphics application 40 may merge the image graphics data 80 and associated meta-data 90 into a single data stream that is formatted for printing by graphics application 40. Preferably, graphics application 40 is adapted to format the image graphics data 80 and notation data 82 for printing on media objects 50 of various sizes by communicating with a system settings storage, e.g., a system registry or initialization file.

Graphics application 40 is preferably implemented as an instruction set(s), or program, of computer-readable logic. The instruction set is preferably maintained on any one of various conventional computer-readable mediums. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium now known or later developed.

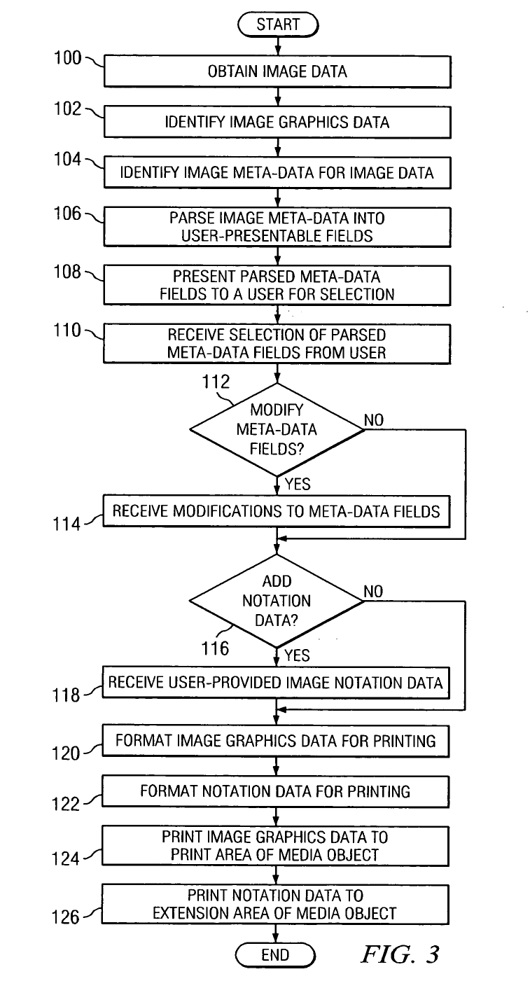

FIG. 3 is a flow diagram illustrating an embodiment of an image printing method in accordance with the present invention. The method begins at block 100, where system 10 obtains image data 70. Image data 70 may be read from a memory card via interface 32, received from a networked computer resource, and/or retrieved from database 42. At block 102, graphics application 40 identifies image graphics data 80 of image data 70 representing a displayable and/or printable image. At block 104, graphics application 40 identifies image meta-data 90 associated with the image.

At block 106, graphics application 40 parses a subset of at least one field of image meta-data 90. At block 108, graphics application 40 displays or otherwise presents to a user the parsed subset of field(s) of image meta-data 90. For example, the parsed subset of image meta-data 90 may be presented on a displayed screen or other type of output device 14 to enable the user to select desired field(s) of the parsed subset of meta-data 90. At block 110, graphics application 40 receives a selection of field(s) of the parsed subset of image meta-data 90 from the user.

At decisional block 112, a determination is made whether a modification to field(s) of the parsed image meta-data 90 is desired. For example, system 10 may be configured to enable the user to modify the information contained in the parsed field(s) of image meta-data 90. If the user desires to modify the parsed field(s) of image meta-data 90, the method proceeds to block 114, where graphics application 40 receives the desired modifications to the parsed field(s) of image meta-data 90. If the user does not desire to modify the parsed field(s) of image meta-data 90, the method proceeds from block 112 to decisional block 116, where a determination is made whether the user desires to add or input additional notation information to associate with the image. For example, system 10 may be configured to combine notation information input by the user to system 10 with notation information extracted from image meta-data 90. If the user desired to add or input additional notation information, the method proceeds to block 118, where graphics application 40 receives user-provided image notation data 92. If the user does not desire to provide additional notation information, the method proceeds from block 116 to block 120.

At block 120, graphics application 40 formats image graphics data 80 for printing. At block 122, graphics application 40 formats notation data 82 for printing. For example, application 40 converts and/or translates textual and/or audible notation information received from the user into a format suitable for printing. At block 124, graphics application prints image graphics data 80 to print area 52 of media object 50. At block 126, graphics application 40 prints notation data 82 to extension area 54 of media object 50. In some embodiments, system 10 is configured to print image graphics data 80 and notation data 82 simultaneously or in such a manner such that image graphics data 80 and notation data 82 is printed to media object 50 as media object makes a single pass through a printing device or past a printing mechanism. In other embodiments, system 10 may be configured to print image graphics data 80 and notation data 82 to media object 50 in a desired or predetermined order. Thus, preferably, upon completion of a printing operation associated with media object 50, media object 50 is ejected or otherwise discharged from a printing device or mechanism having image graphics data 80 and notation data 82 printed thereon.

Thus, embodiments of the present invention enable a user to print notation information associated with a particular image to a portion of a media object 50 while enabling the user to obtain a borderless printing of the image. For example, the notation information may remain part of the media object 50 or may be removed to produce a borderless printing of the image. The notation information may be extracted from data field(s) associated with the image data file and/or may be input by the user. Additionally, if the notation information is extracted from data field(s) associated with the image data file, the user may have the option of selecting and/or modifying particular field(s) of the extracted notation information.

It should be understood that in the method described in FIG. 3, certain functions may be omitted, combined, or accomplished in a sequence different than depicted in FIG. 3. Also, it should be understood that the method depicted in FIG. 3 may be altered to encompass any of the other features or aspects described elsewhere in the specification.

1. An image printing system, comprising:
a graphics application executable by a processor, the graphics application adapted to print image graphics data in a print area of a media object, the graphics application adapted to print image notation data to an extension area of the media object.

2. The system of claim 1, wherein the extension area of the media object comprises a removable tab.

3. The system of claim 1, wherein the extension area of the media object comprises a perforated tab.

4. The system of claim 1, wherein the image notation data comprises meta-data extracted from a header associated with the image graphics data.

5. The system of claim 1, wherein the image notation data comprises user-provided data received from a user via an input device.

6. The system of claim 1, wherein the graphics application is disposed in at least one of the group consisting of a scanner, a copier, a printer, and a computer.

7. The system of claim 1, wherein the graphics application is adapted to extract the image notation data from image meta-data.

8. The system of claim 1, wherein the graphics application is adapted to parse at least one field of image meta-data to identify the notation data.

9. The system of claim 1, wherein the graphics application is adapted to display to a user for selection as the notation data at least one field of parsed image meta-data.

10. The system of claim 1, wherein the graphics application is adapted to receive from a user a selection of at least one field of parsed image meta-data as the notation data.

11. An image printing method, comprising:
receiving image graphics data;
identifying, via a graphics application, image notation data associated with the image graphics data;
printing, via the graphics application, the image graphics data to a print area of a media object; and
printing, via the graphics application, the image notation data to an extension area of the media object.

12. The method of claim 11, wherein identifying image notation data comprises extracting the image notation data from a header associated with the image graphics data.

13. The method of claim 11, wherein identifying image notation data comprises receiving user-provided image notation data.

14. The method of claim 11, wherein printing the image notation data comprises printing the image notation data to a removable tab of the media object.

15. The method of claim 11, wherein printing the image notation data comprises printing the image notation data to a perforated tab of the media object

16. The method of claim 11, wherein receiving image graphics data comprises receiving image graphics data via a memory card interface.

17. The method of claim 11, wherein identifying image notation data comprises parsing at least one field of image meta-data.

18. The method of claim 11, further comprising presenting to a user for selection as the notation data at least one field of parsed image meta-data.

19. The method of claim 11, further comprising receiving a selection from a user of at least one field of parsed image meta-data as the notation data.

20. A computer-readable medium having stored thereon an instruction set to be executed, the instruction set, when executed by a processor, causes the processor to:
identify graphics image data;
identify image notation data associated with the graphics image data;
print the graphics image data to a print area of a media object; and
print the image notation data to an extension area of the media object.

21. The computer-readable medium according to claim 20, wherein the instruction set, when executed by the processor, causes the processor to extract the image notation data from a header associated with the image graphics data.

22. The computer-readable medium according to claim 20, wherein the instruction set, when executed by the processor, causes the processor to identify user-provided image notation data.

23. The computer-readable medium according to claim 20, wherein the instruction set, when executed by the processor, causes the processor to parse at least one field of image meta-data to identify the notation data.

24. The computer-readable medium according to claim 20, wherein the instruction set, when executed by the processor, causes the processor to display to a user for selection as the notation data at least one field of parsed image meta-data.

25. The computer-readable medium according to claim 20, wherein the instruction set, when executed by the processor, causes the processor to receive from a user a selection of at least one field of parsed image meta-data as the notation data.

26. An image printing system, comprising:
means for receiving image graphics data;
means for identifying, via a graphics application, image notation data associated with the image graphics data;
means for printing the graphics image data to a print area of a media object; and
means for printing the image notation data to an extension area of the media object.

27. The system of claim 26, further comprising means for extracting the image notation data from a header associated with the graphics image data.

28. The system of claim 26, further comprising means for receiving user-provided image notation data from a user.

29. The system of claim 26, further comprising means for presenting to a user for selection as the notation data at least one field of parsed image meta-data.

30. The system of claim 26, further comprising means for receiving a selection from a user of at least one field of parsed image meta-data as the notation data.
